(19) United States
(12) Patent Application Publication
(10) Pub. No.: US 2010/0299001 A1
(43) Pub. Date: Nov. 25, 2010

(54) VEHICLE COMMUNICATION TERMINAL AND VEHICLE COMMUNICATION SYSTEM IN WHICH RADIO TRANSMISSIONS BY THE VEHICLE COMMUNICATION TERMINALS ARE CONTROLLED BY RADIO COMMUNICATION FROM BASE STATIONS

(75) Inventor: Tadao SUZUKI, Kariya-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/785,741

(22) Filed: May 24, 2010

(30) Foreign Application Priority Data
May 25, 2009 (JP) 2009-125737

(51) Int. Cl. G06F 7/00; H04B 7/00

(52) U.S. Cl. 701/2

(57) ABSTRACT

In a vehicle communication system, a base station transmits radio signals conveying transmission control designation information to communication terminals of respective vehicles, and each vehicle communication terminal performs control of radio signal transmissions based on the most recently received transmission control designation information. Control may be specified for selected vehicle communication terminals or for all of the terminals, and can consist of selectively enabling/halting radio signal transmission, determining a maximum level of transmission power, etc. Information specifying a time point at which the transmission control is to commence may also be conveyed, and each vehicle communication terminal relays the received transmission control designation information to other vehicles, thereby increasing the effective service area of each base station.

### CROSS-REFERENCE TO RELATED APPLICATIONS

This application is based on and incorporates herein by reference Japanese Patent Application No. 2009-125737 filed on May 25, 2009.

### BACKGROUND OF THE INVENTION

1. Field of the Invention

The present invention relates to a vehicle communication terminal conveyed by a motor vehicle, configured for communication with roadside base stations and with vehicle communication terminals of other vehicles. The invention further relates to a communication system which incorporates such vehicle communication terminals and roadside base stations.

2. Description of Related Technology

Types of inter-vehicle communication are known whereby information is exchanged between motor vehicles by means of communication terminals conveyed by the vehicles (where the term “communication” as used herein refers to communication of information between machines). Since such inter-vehicle communication is performed directly by radio without using a public telephone system, information can be rapidly acquired from other vehicles. Hence, such inter-vehicle communication has been envisaged for application to vehicle safety support systems, i.e., systems for preventing collisions between vehicles, etc. With such vehicle safety support systems, a high speed of processing and high speed of data transfer are essential.

For example as described in Japanese patent application publication No. 2004-199390 (designating a vehicle under consideration as the “local vehicle”), technology is proposed whereby the possibility of collision between the local vehicle and another vehicle is judged based upon the position, speed and direction of the local vehicle and upon information that is obtained (by inter-vehicle communication) from the other vehicle, such as the position, speed and motion direction of that other vehicle. If it is determined that there is a possibility of collision with the other vehicle, measures are taken by a vehicle safety support system such as generating warning signals directed to the driver of the local vehicle. If necessary, intervention may be performed, whereby the vehicle safety support system takes control of the brakes, steering, etc., of the local vehicle.

Furthermore, communication systems are known in which roadside base stations (i.e., base stations located adjacent to a road) communicate with vehicle communication terminals by radio. Such a type of communication is referred to in the following as road-to-vehicle communication. It is known to utilize road-to-vehicle communication for example to acquire and distribute provide information concerning traffic congestion, and safety support information, and also with ETC (Electronic Toll Collection) systems for automatically collecting vehicle toll fees, etc.

At present, with advances occurring in technology (for example the conversion from analog television broadcasting to digital broadcasting) changes are being made in allocations of parts of the radio frequency spectrum for communication purposes. The frequency bands in the electromagnetic spectrum which have allocated for vehicle communication (inter-vehicle communication and road-to-vehicle communication) overlap with frequency bands used for other purposes. Hence, changes are being proposed in the frequency bands allocated for such types of vehicle communication, and it is necessary for vehicle communication terminals to be adapted to these changes. In particular, it will be necessary for vehicle communication terminals to have a capability for automatic control of halting and starting transmissions.

Here, “automatic control” signifies that starting or halting of radio signal transmissions appropriately, and setting of the appropriate transmission power level, etc., are not required to be controlled manually by a vehicle driver, but are handled through road-to-vehicle communication with a roadside base station. Such a type of transmission control is well known for application to mobile (voice) telephone systems, for example.

In the case of a mobile telephone system such as a cell phone system, the sizes and locations of the individual service areas (cells) of base stations of the system can be such that adjacent cells overlap,. Hence, a large total size of service area can be achieved. However in the case of roadside base stations used for communication with vehicle communication terminals, the service area of each roadside base station is small, and in general it cannot be ensured that they overlap. Thus even if a vehicle communication system has a plurality of roadside base stations, it has not been possible for such a system to perform integrated control of vehicle communication terminals over a wide area.

### SUMMARY OF THE INVENTION

It is an objective of the present invention to overcome the above problem, by providing a vehicle communication terminal whereby radio wave transmissions are selectively enabled based on transmission control designation information which is received by radio from an external (ground-based) apparatus, and by providing a vehicle communication system in which a plurality of vehicles equipped with such vehicle communication terminals can perform inter-vehicle communication.

To achieve the above objective, according to a first aspect the invention provides a vehicle communication terminal comprising a receiver circuit and transmitter circuit, and a transmission control circuit which controls transmissions of radio signals by the transmitter circuit in accordance with transmission control designation information, when such designation information is received, conveyed by a radio signal, by the receiver circuit.

Transmission may be performed by a vehicle communication terminal for inter-vehicle communication, i.e., for transmitting/receiving information to/from other vehicles (information such as vehicle positions, speeds, and motion directions), or for communication with a roadside base station (road-to-vehicle communication).

The term “vehicle” is used herein to refer to motor vehicles in general, including both four-wheel and two-wheel motor vehicles.

The contents of the transmission control designation information may constitute a transmission enable/halt command, for enabling or halting radio signal transmissions by the vehicle communication terminal which receives the command, i.e., with the transmission control circuit of a vehicle communication terminal being configured to control the transmitter circuit in accordance with such a received command.

The contents of the transmission control designation information may also constitute a maximum transmission power command, designating an upper limit level of transmission power of the transmitter circuit of a vehicle communication terminal.

Furthermore by specifying that limit level as zero, such a maximum transmission power command can be used to designate that transmitting of radio signals by the receiving vehicle communication terminal is to be halted. In that case, it becomes unnecessary to provide separate commands for specifying the maximum transmission power level and for designating enabling/halting of transmissions.

Moreover, the transmission control designation information may be accompanied by control-time information, designating a time point at which transmission control is to be performed in accordance with the transmission control designation information.

This can provide the following advantages. With a portable telephone system such as a cell phone system, transmission operations of the individual portable telephones (enabling/halting transmission, level of transmission power, etc.) can be controlled by radio signals transmitted from a base station. However such a features has not been available hitherto for vehicle communication terminals. In the case of a vehicle communication system, a roadside base station can perform such control of transmissions by a vehicle communication terminal. However such a roadside base station has only a very limited communication area (service area), and can only control transmission operations of vehicles which are currently within that limited area. It has not been possible hitherto to provide a vehicle communication system whereby such transmission control can be achieved over a wide area, as is possible for example with a cell phone system.

However with the present invention, when transmission control designation information accompanied by such control-time information are received by a vehicle communication terminal, the transmission control designation information is stored. Subsequently when the time point designated by the control-time information is reached, transmission control is applied in accordance with the stored transmission control designation information.

In that way, even if that vehicle communication terminal has moved out of the service area of the roadside base station when the specified time point is reached, transmission control can still be applied in accordance with the contents of the transmission control designation information.

Thus the effective service area of each roadside base station can be substantially increased, so that integrated transmission control of a plurality of vehicle communication terminals can be achieved over a large area.

The term “transmission control information group” is used herein to refer to a data set consisting of transmission control designation information items arranged in a predetermined data format.

Such a transmission control information group may include time stamp information, expressing the time point at which this group was generated by a roadside base station. In that case for example, a vehicle communication terminal can be configured to judge whether the received transmission control designation information is excessively old, and thus may not be reliable. When such a condition is judged to exist, then it may be predetermined that transmission control will not be performed in accordance with the received transmission control information group, or that the transmission control will be modified in some manner. Adverse effects of using unreliable information can thereby be reduced.

The invention further provides a vehicle communication system comprising vehicle communication terminals, each as described above, conveyed by respective vehicles, and one or more roadside base stations for transmitting radio signals conveying transmission control information groups as described above.

Each of the vehicle communication terminals preferably comprises an inter-vehicle communication section, for exchanging information with the vehicle communication terminals of other vehicles of the system. Furthermore, each vehicle communication terminal is preferably configured to utilize the inter-vehicle communication section for relaying (to the vehicle communication terminals of one or more other vehicles) transmission control designation information and other traffic-related information received from a roadside base station. Specifically, when a vehicle communication terminal receives such information from a roadside base station, it then retransmits the information, to be received by other vehicle communication terminals (e.g., which may be out of reception range of the roadside base station).

In that way, vehicles which are out of range of a roadside base station can perform transmission control in accordance with transmission control designation information that has been transmitted by a roadside base station. The effective service area of each roadside base station can thereby be enlarged.

Preferably, the transmission control designation information expresses at least a transmission enable/halt command and a maximum transmission power command, or at least one of these.

Furthermore with the present invention, each transmission control information group preferably includes destination information for identifying one or more vehicle communication terminals as a destination of that transmission control information group. This enables more effective control of a vehicle communication system, since requirements for transmission control will differ among the various vehicles that are currently operating in the system.

A plurality of roadside base stations of such a vehicle communication system may each communicate (e.g., via a data communication network) with a management center. The management center is a facility which performs integrated control of the overall vehicle communication system, based on information concerning vehicle positions, speeds, etc., transmitted to it from the roadside base stations.

### BRIEF DESCRIPTION OF THE DRAWINGS

FIG. 1 is a block diagram conceptually illustrating an embodiment of a driving safety support system;

FIG. 2 is a general system block diagram of a roadside base station of the embodiment;

FIG. 3 is a general system block diagram of a vehicle communication terminal of the embodiment;

FIG. 4 shows an example of a format of a transmission control information group, used in communication by the embodiment;

FIG. 5 is a flow diagram illustrating a normal-operation sequence executed by a roadside base station;

FIG. 6 is a flow diagram illustrating a special operation sequence executed by a roadside base station for halting transmissions by all vehicle communication terminals;

FIG. 7 is a flow diagram illustrating an operation sequence executed by a vehicle communication terminal of the embodiment;

FIG. 8 is a flow diagram illustrating received signal judgement processing which is performed by a vehicle communication terminal;

FIG. 9 is a flow diagram of operation judgement processing which is performed by a vehicle communication terminal;

FIG. 10 is a flow diagram of processing for determining the contents of a transmission control information group which is to be transmitted by a vehicle communication terminal;

FIG. 11 is a flow diagram of transmission judgement processing which is performed by a vehicle communication terminal; and

FIG. 12 is a flow diagram of display processing performed by a vehicle communication terminal.

### DESCRIPTION OF PREFERRED EMBODIMENTS

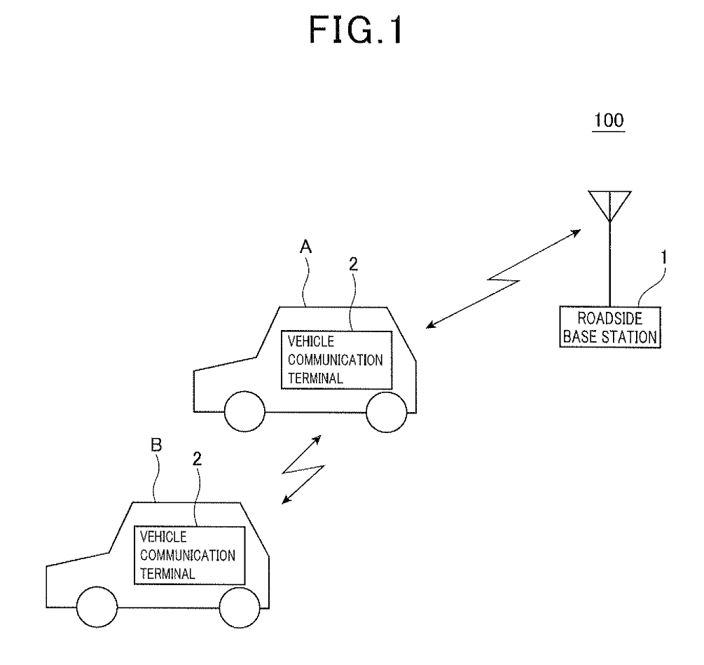

FIG. 1 conceptually illustrates the basic configuration of an embodiment of a vehicle communication system functioning as a driving safety support system 100, which provides driving safety support to a plurality of motor vehicles. The system of the embodiment contains a plurality of roadside base stations, however for simplicity of description only a single roadside base station 1 is shown. Respective vehicle communication terminals 2 are conveyed by motor vehicles A, B that are currently within the service area of the roadside base station 1. Information can be exchanged between the roadside base station 1 and each vehicle communication terminal 2 (i.e., road-to-vehicle communication) and can be exchanged between the vehicle communication terminals 2 of respective vehicles A, B (inter-vehicle communication). Driving safety support is thereby provided to the vehicles, in accordance with the environmental traffic conditions, etc. Here, “driving safety support” includes, in addition to providing information concerning traffic conditions in the environment of a vehicle, providing information concerning street obstructions, information concerning traffic signals, and also (when dangerous circumstances arise) providing precautionary messages to the vehicle driver, generating warning signals to the driver requesting that some action such as braking be performed, or if necessary performing intervention control by automatically decelerating the vehicle, controlling the steering, and/or applying braking.

More particularly, designating one of the vehicles as the local vehicle, information concerning other vehicles, pedestrians, etc., in the environment of the local vehicle is received by the vehicle communication terminal 2 of the local vehicle through road-to-vehicle communication from the roadside base station 1. Based on the received information, driving safety support is provided to the driver of the local vehicle, e.g., by providing notifications for enabling the driver to avoid accidents when performing a right turn or left turn of the vehicle at a street intersection. Furthermore the local vehicle can receive information concerning other vehicles or pedestrians who are located within a “blind spot” of the range of vision of the driver of the local vehicle. In that case, the information may be received by inter-vehicle communication from the vehicle communication terminal 2 of an oncoming vehicle, for example. The local vehicle may also acquire information from a preceding vehicle, by inter-vehicle communication with the vehicle communication terminal 2 of the preceding vehicle, such as information concerning the running conditions of the preceding vehicle (e.g., its position relative to the local vehicle, its current speed and direction of motion, etc.). In that case, the acquired information is used to provide driving safety support to the driver of the local vehicle, e.g., by generating messages or warning indications for enabling the driver to avoid accidents such as rear-end collisions with preceding vehicles.

In addition, the roadside base station 1 receives information concerning the running conditions of vehicles within its service area (i.e., locations, speeds, motion directions of the vehicles) from the vehicle communication terminals 2 of these vehicles, by road-to-vehicle communication. This acquired information can be used to achieve an improved level of traffic management, and to increase the accuracy of traffic information obtained by the roadside base station 1. The acquired information can thus further assist in preventing traffic accidents.

The driving safety support system 100 essentially differs from prior art types of vehicle communication system designed to provide driving safety support, in that the roadside base station 1 can manage the transmission of radio signals by vehicle communication terminals 2, as described in the following. Only those operations of the driving safety support system 100 differ from the prior art will be described in detail. For example, each vehicle communication terminal periodically transmits running condition information (expressing the location, speed, etc., of the corresponding vehicle) to be received by vehicle communication terminals of other vehicles, however this feature is not specifically described.

The vehicle safety support system of this embodiment comprises a plurality of roadside base stations 1 disposed at various location, each roadside base station 1 capable of communicating with a plurality of vehicle communication terminals 2 of vehicles that are within its service area. Integrated management of the roadside base stations 1 as a system is performed by a management center (not shown in the drawings), which is connected to the roadside base stations 1 via a data communication network. However it would also be possible to configure a vehicle communication system in accordance with the present invention which contains only a single roadside base station 1, without a management center.

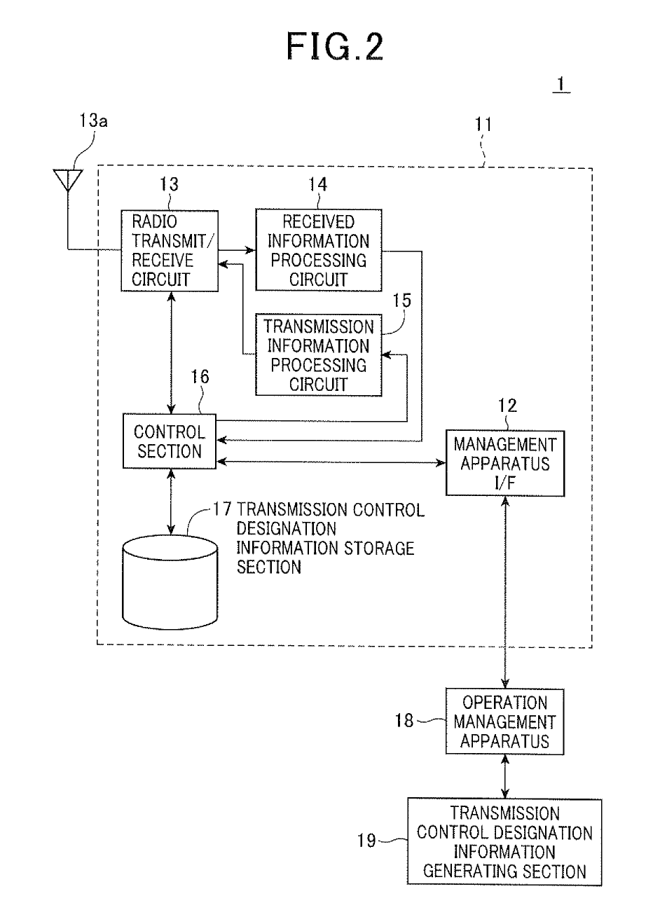

Firstly, the configuration of the roadside base station 1 will be described referring to the block diagram of FIG. 2. As shown, the roadside base station 1 basically consists of a roadside communication terminal 11, an operation management apparatus 18 and a transmission control designation information generating section 19. The roadside communication terminal 11 is made up of an operation management I/F (interface) 12, a radio transmit/receive circuit 13, a communication (transmit/receive) antenna 13a, a received information processing circuit 14, a transmission information processing circuit 15, a control section 16 and a transmission control designation information storage section 17.

The operation management apparatus 18 receives information which is collected by the roadside communication terminal 11 concerning running conditions of vehicles, transferred via the management apparatus I/F 12. The operation management apparatus 18 processes this to generate road-to-vehicle service information, and supplies this information to the roadside communication terminal 11. The roadside communication terminal 11 transmits a radio signal conveying the road-to-vehicle service information to those vehicle communication terminals 2 that are within its service area.

The road-to-vehicle service information is derived based on the information concerning running conditions of vehicles that is supplied from the roadside communication terminal 11, and also upon information that is otherwise acquired, relating to the environment adjacent to the roadside base station 1. Such other information can include the current state of traffic congestion in the vicinity of the roadside base station 1, road obstructions, the conditions of traffic signals, etc.

At least a part of this other information may be supplied from the management center. Each roadside base station 1 also transmits information concerning vehicles in its vicinity (i.e., within its service area) from the operating management apparatus 18 to the management center.

The operation management apparatus 18 also acquires information concerning the status of the communication functions of the vehicle communication terminals 2, collected from the vehicle communication terminals 2 by the roadside communication terminal 11. This information is supplied to the transmission control designation information generating section 19 by the operation management apparatus 18, and based on it, the transmission control designation information generating section 19 performs processing to generate the transmission control information groups. As described hereinafter, each transmission control information group is formed of a set of transmission control designation information items, which constitute commands and information for controlling transmission operations of a vehicle communication terminal 2. The operation management apparatus 18 performs processing for transferring each newly generated transmission control information group from the transmission control designation information generating section 19 to the roadside communication terminal 11, and for transferring road-to-vehicle service information to the roadside communication terminal 11 (e.g., at timings when such transfer is designated by the management center).

The operation management I/F 12 transfers road-to-vehicle service information from the operation management apparatus 18 to the control section 16, and transfers vehicle running condition information from the control section 16 to the operation management apparatus 18.

With this embodiment, each time a transmission control information group is transmitted by the roadside communication terminal 11, road-to-vehicle service information is also transmitted.

The transmission information processing circuit 15 receives each transmission control information group and the accompanying road-to-vehicle service information, and encodes and converts these to a modulation signal which is supplied to the radio transmit/receive circuit 13. The radio transmit/receive circuit 13 thereby generates a transmission signal (modulated high-frequency carrier) conveying the transmission control information group and road-to-vehicle service information, which is supplied to the communication antenna 13a, to be transmitted as a radio signal over a predetermined area (service area).

The radio transmit/receive circuit 13 also receives radio signals from the antenna 13a, conveying information transmitted from vehicle communication terminals 2 concerning vehicle running conditions, etc.

The received information processing circuit 14 demodulates and decodes these received radio signals, and transfers the information conveyed by the radio signals concerning vehicle running conditions, etc., to the control section 16.

The control section 16 is configured as a usual type of microcomputer, formed of a CPU, ROM, RAM and I/O devices, which are interconnected by bus lines. Since such a configuration is well known, these components are omitted from the drawings. The ROM of the control section 16 holds a stored program which is executed by the CPU. The control section 16 thereby performs processing for controlling various operations of the roadside communication terminal 11, and transferring data (commands and information) as described in the following.

Each time that a transmission control information group and road-to-vehicle service information are newly supplied to the control section 16 from the operation management apparatus 18 (transferred via the operation management I/F 12), the control section 16 stores these data in the transmission control designation information storage section 17 (i.e., replacing previously stored information). Thereafter, these currently stored contents are periodically read out and supplied to the transmission information processing circuit 15, to be transmitted as a modulated and encoded radio signal by the radio transmit/receive circuit 13. The control section 16 also receives information concerning running conditions of vehicles from the received information processing circuit 14 (i.e., information received by the radio transmit/receive circuit 13 from the vehicle communication terminals 2 of vehicles that are in the local service area). The control section 16 supplies this information to the operation management I/F 12, to be transferred to the operation management apparatus 18. Such information may also be transferred from the operation management apparatus 18 to the management center.

Each roadside base station 1 is assigned a corresponding identifier, referred to in the following as its roadside apparatus ID.

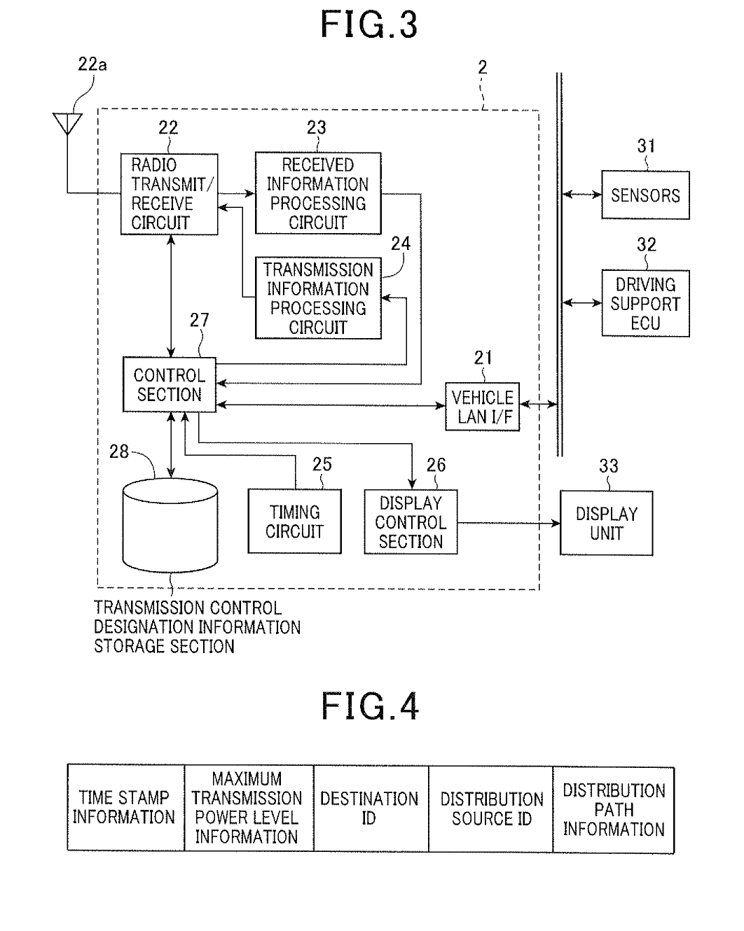

The overall configuration of a vehicle communication terminal 2 is illustrated in the block diagram of FIG. 3. As shown, this is basically formed of a vehicle LAN (Local Area Network) I/F 21, a radio transmit/receive circuit 22, a communication antenna 22a, a radio transmit/receive circuit 22, a received information processing circuit 23, a transmission information processing circuit 24, a timing circuit 25, a display control section 26, a control section 27 and a transmission control designation information storage section 28. The vehicle LAN I/F 21 is a communication interface apparatus, for transmitting and receiving information between the control section 27 and a number of equipment units of the vehicle, via a vehicle LAN communication network, in accordance with a network protocol such as the CAN (Controller Area Network) protocol. These equipment units which are connected via the vehicle LAN include a plurality of sensors 31 and a driving support ECU 32 (Electronic Control Unit) 32, described hereinafter.

The sensors 31 are installed at various positions on the local vehicle, for detecting the running condition of the local vehicle (where “running condition” signifies information such as the current location, speed, etc., of the vehicle). The sensors 31 may for example include a vehicle speed sensor, steering sensor, gyroscope, terrestrial magnetic field sensor, travel distance sensor, GPS (Global Positioning System) apparatus, brake sensor, etc.

The driving support ECU 32 is an electronic control unit which controls the level of driving safety support in accordance with an extent of danger of an accident. The driving safety support has four levels, having successively increasing degrees of stringency, i.e.,:

(1) (lowest level) providing information to the driver concerning possible danger,

(2) generating precautionary messages directed to the driver,

(3) generating warning signals directed to the driver, and

(4) (highest level) intervention (taking control of the accelerator, and/or brakes and/or steering of the vehicle, to avoid a collision or reduce the impact of a collision).

The respective functions and operation of the radio transmit/receive circuit 22, the communication antenna 22a, the received information processing circuit 23 and the transmission information processing circuit 24 are similar to those of the radio transmit/receive circuit 13, the communication antenna 13a, the received information processing circuit 14 and the transmission information processing circuit 15 respectively of the roadside base station 1 described above, so that detailed description will be omitted. In this case, radio signals transmitted by the radio transmit/receive circuit 22 from the communication antenna 22a (when transmission is enabled by control commands from the control section 27) are modulated with encoded information supplied from the transmission information processing circuit 24. This may be information concerning the running condition of the local vehicle, or a transmission control information group and road-to-vehicle service information which are being relayed, i.e., which is being transmitted after having been received directly from a roadside base station 1 or relayed from another vehicle, as described hereinafter. Radio signals may be transmitted to a roadside base station 1 or the vehicle communication terminals 2 of other vehicles.

The radio transmit/receive circuit 22 also receives radio signals transmitted from a roadside base station 1 or from the vehicle communication terminals 2 of other vehicles, and hence functions both as a road-vehicle communication section (for communication with a roadside base station) and also as an inter-vehicle communication section of the vehicle communication terminal 2.

The received information processing circuit 23 demodulates and decodes radio signals received by the radio transmit/receive circuit 22, and sends each transmission control information group, street-to-vehicle service information and vehicle running condition information that are obtained from the radio signals to the control section 27, to be stored in the control section 27 (replacing previously stored information). The transmission information processing circuit 24 encodes information concerning the current running condition of the local vehicle, and the most recently obtained transmission control information group and road-to-vehicle service information, which are read out from the transmission control designation information storage section 28 and supplied by the control section 27 (in modified form, as described hereinafter) to the transmission information processing circuit 24. The encoded information is supplied by the transmission information processing circuit 24 to the radio transmit/receive circuit 22, for modulating a radio signal that is transmitted by the communication antenna 22a, to be received by the vehicle communication terminals of other vehicles.

The timing circuit 25 utilizes a quartz crystal-controlled oscillator for time measurement. The display control section 26 displays the contents of commands which are supplied from the control section 27, on the display unit 33. The display unit 33 can be a LCD (liquid crystal display unit), organic EL (electroluminescent) display unit, a plasma display unit, etc.

It should be noted that it is not essential that the display unit 33 is a display device dedicated to the functions of the present invention, and that it would be possible for example to use the display unit of a vehicle navigation apparatus of the local vehicle to also perform the functions of the display unit 33.

The control section 27 is configured as a usual type of microcomputer, formed of a CPU, ROM, RAM and I/O devices (not shown in the drawings). The ROM of the control section 27 holds a stored program which is executed by the CPU of the control section 27 to perform processing relating to various control operations and transferring of data.

The control section 27 performs transmission control for controlling the level of transmission power of the radio transmit/receive circuit 22 and for selectively enabling and halting radio signal transmission by the radio transmit/receive circuit 22. This transmission control function of the control section 27 is executed based upon contents of the current (i.e., most recently received) transmission control information group, which is stored in the transmission control designation information storage section 28 by the control section 27 when received, as described above.

The control section 27 can also perform time-related control transmissions by the radio transmit/receive circuit 22 in accordance with the time stamp information of the current transmission control information group, and (if also received) control-time information which specifies a time point for commencing transmission control. Such time-related control is performed in conjunction with time information supplied by the timing circuit 25. The control section 27 also supplies commands to the display control section 26 for determining the contents of messages, etc., that are to be displayed by the display unit 33, based on the current transmission control information group. Furthermore, based on the current transmission control information group, the control section 27 issues commands to the driving support ECU 32 via the vehicle LAN I/F 21 for changing the level of driving safety support provided by the driving support ECU 32. Moreover, based on the current transmission control information group, the control section 27 generates a modified transmission control information group which is to be transmitted to the vehicle communication terminals 2 of other vehicles, and supplies this to the transmission information processing circuit 24.

With this embodiment, the modified transmission control information group differs from the current transmission control information group only in containing an indication that the modified transmission control information group is not directly transmitted from a roadside base station 1.

The control section 27 also supplies information concerning the running conditions of the local vehicle (acquired from the sensors 31 via the vehicle LAN I/F 21) to the transmission information processing circuit 24, to be transmitted by the radio transmit/receive circuit 22.

Each vehicle communication terminal 2 is assigned a corresponding identifier, referred to in the following as the vehicle communication terminal ID, which is conveyed with each radio signal transmitted by that vehicle communication terminal 2.

FIG. 4 shows the contents of a transmission control information group as utilized with this embodiment. It should be understood that these contents are shown only by way of example, and that various other contents are possible. The transmission control information group contains five items, arranged in a predetermined data format. The first of these items expresses time stamp information, indicating the time point at which this transmission control information group was generated by a roadside base station 1 (i.e., the roadside base station 1 which originally distributes this transmission control information group). The second, third, fourth and fifth items respectively express maximum transmission power information, a destination ID, a distribution source ID, and distribution path information.

The maximum transmission power information specifies the maximum level of power at which radio signals are to be transmitted by the radio transmit/receive circuit 22 of a vehicle communication terminal 2 which is a destination of this transmission control information group. The destination ID information specifies the vehicle communication terminal ID of a vehicle communication terminal 2 which is the destination of this transmission control information group, or specifies all vehicle communication terminals as being destinations.

Specifically, when the transmission control information group is to be directed to all of the vehicle communication terminals 2 rather than to a single specific vehicle communication terminal, the destination ID is set as “99999999”. The default value of the destination ID is “00000000”.

The distribution source ID specifies the roadside apparatus ID of the distribution source, i.e., the roadside base station 1 which originally generates and distributes this transmission control information group. The distribution path information indicates whether this transmission control information group (when received by a vehicle communication terminal) has been transmitted directly or indirectly from a roadside base station 1.

With this embodiment the time stamp information indicates the time at which the transmission control information group was generated, in the format “year, month, day” and “hour, minute, second”. The default time stamp information is set as “year 00, month 00, day 00” and “hour 00, minute 00, second 00”.

The maximum transmission power information specifies the power level (maximum transmitted power level to be produced by a radio transmit/receive circuit 22) as a number of dBm, i.e., in the form “YY dBm”.

With this embodiment, the maximum transmission power information is also used to perform a command function, for specifying whether transmission of radio signals by the radio transmit/receive circuit 22 of the receiving vehicle communication terminal 2 is to be enabled or inhibited. Specifically, if the transmission is to be inhibited, the maximum transmission power information is set as “99 dBm”. If the maximum transmission power information is set at a value other than “99 dBm”, then this indicates that transmission of radio signals by the radio transmit/receive circuit 22 of the receiving vehicle communication terminal 2 is to be enabled. Thus with this embodiment, the maximum transmission power information also constitutes a transmission enable/halt command. The default value of the maximum transmission power information is “00 dBm”.

It should be noted that the invention is not limited to a system in which the maximum transmission power information is used to specify a maximum transmission power level and also is used as a transmission enable/halt command. It would be equally possible to provide maximum transmission power information that specifies only a maximum level of transmission power, and a transmission enable/halt command, as respectively separate items in a transmission control information group.

If the roadside base station 1 which is the distribution source of the transmission control information group is defective, then the distribution source ID is set as “99999999”. The default value of the distribution source ID is “00000000”.

When a transmission control information group is transmitted from a roadside base station 1, the distribution path information is set as “0”. When a transmission control information group that has been originally transmitted from a roadside base station 1 is to be retransmitted (i.e., relayed) from a vehicle communication terminal 2, the transmission control information group is modified by setting the distribution path information as “1”.

The distribution path information is set as “1” both for the case in which the transmission control information group is transmitted from a vehicle communication terminal 2 after having been received directly from a roadside base station 1, and for the case in which it is transmitted from a vehicle communication terminal 2 of a vehicle after having been received from a vehicle communication terminal 2 of another vehicle. Thus the distribution path information indicates whether a transmission control information group is received directly or indirectly from a roadside base station 1.

In addition to the items shown in FIG. 4, a transmission control information group may also be transmitted together with control-time information. This specifies the time point at which a vehicle communication terminal 2 is to begin to perform transmission control in accordance with the accompanying transmission control information group. The time point may be specified directly (i.e., as a time of day) or as an elapsed-time value.

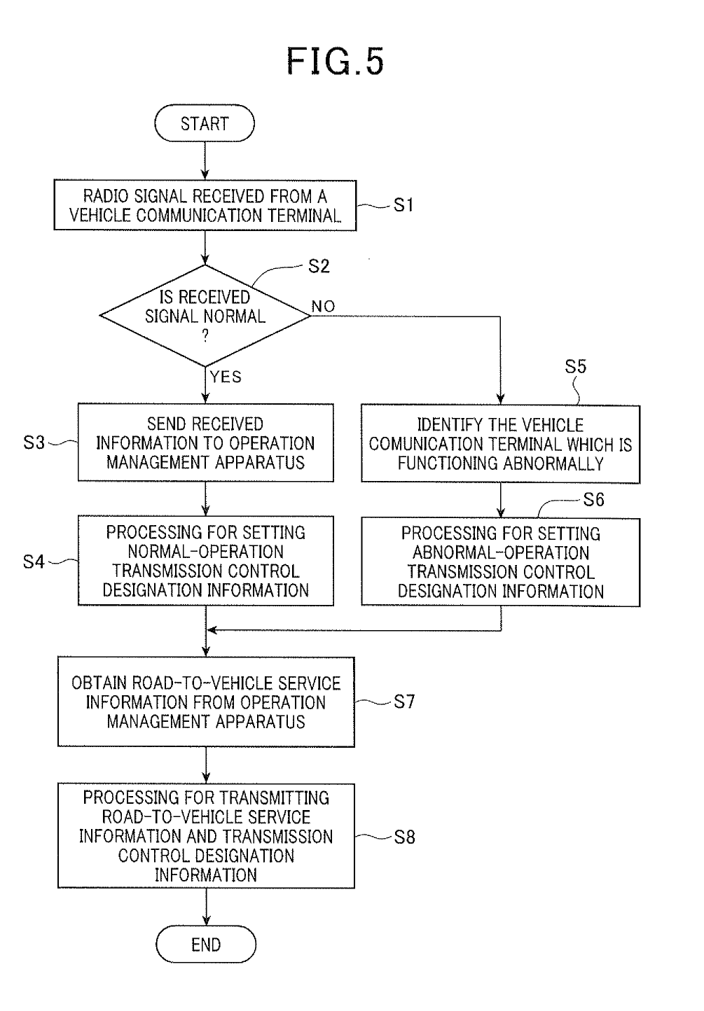

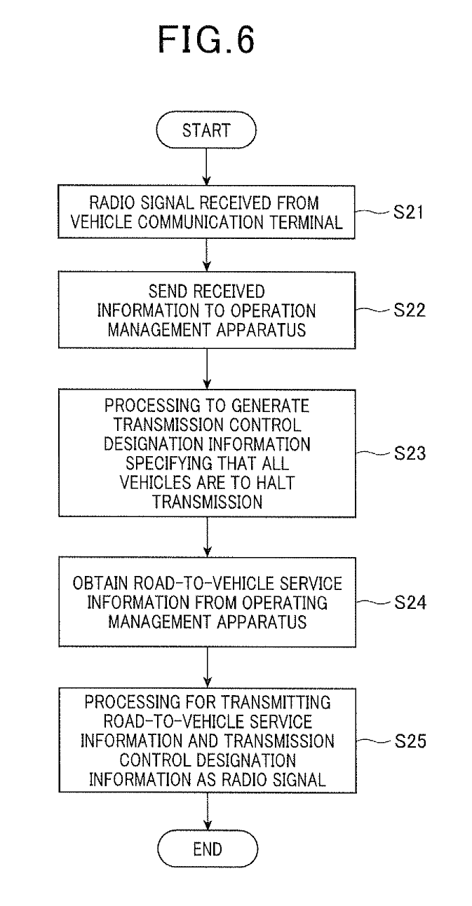

FIG. 5 is a flow diagram illustrating a normal-operation sequence that is executed by a roadside base station 1 when a radio signal conveying vehicle running condition information is received from a vehicle communication terminal 2. Here, “normal operation” is used to distinguish this operation sequence from a special operation sequence (for halting transmissions by all vehicle communication terminals 2) described hereinafter referring to FIG. 6.

When a radio signal is received from a vehicle communication terminal 2 by the radio transmit/receive circuit 13 and demodulated/decoded by the received information processing circuit 14, and is found to convey information concerning the running conditions of a vehicle (step S1), the control section 16 then judges (step S2) whether or not the received radio signal is normal. This judgement may be made based upon the frequency and/or waveform of the (demodulated) radio signal. If the received radio signal is judged to be normal (YES decision in step S2), step S3 is then executed, while if it is judged to be abnormal (NO decision), step S5 is then executed.

In step S3, the information conveyed by the received radio signal, obtained by the received information processing circuit 14, is transferred by the control section 16 via the operation management I/F 12 to the operation management apparatus 18. Normal-operation setting of transmission control designation information (as a transmission control information group) is then performed by the transmission control designation information generating section (step S4), then step S7 is executed.

In normal-operation setting of a transmission control information group, the destination ID is set as “99999999”. This indicates that the destination is all of the vehicle communication terminals 2. The time stamp information is set as the time point at which this is performed. The distribution source ID is set as the roadside apparatus ID of this roadside base station 1. The distribution path information is set as “0”.

With this embodiment the maximum transmission power information is set by the transmission control designation information generating section 19 in accordance with commands transmitted from the management center to the roadside base station 1. The appropriate value of maximum transmission power can be determined by the management center based upon the communication conditions in the vicinity of the roadside base station 1. The maximum value may be determined, for example, such as to limit the maximum transmission power of each vehicle communication terminal 2 (in the service area of the roadside base station 1) sufficiently for preventing mutual interference between communication operations of these vehicle communication terminals, i.e., determined in accordance with the density of traffic in the local service area. However it would also be possible for the control section 16 of a roadside base station 1 itself to determine the appropriate maximum value, based on the local communication conditions.

When it has been determined (in step S2) that a radio signal conveying a transmission control information group has been received from a vehicle communication terminal which is functioning abnormally, the defective vehicle communication terminal is identified in step S5. Specifically in step S2, the control section 16 judges that a vehicle communication terminal is functioning abnormally, based upon the characteristics (frequency, waveform, etc.) of the radio signal received from that vehicle communication terminal, after demodulation.

As described above, the contents of each radio signal transmitted by a vehicle communication terminal 2 include the ID of that vehicle communication terminal. Hence in step S5, the control section 16 obtains the vehicle communication terminal ID which has been received together with the newly received transmission control information group.

Next in step S6, abnormal-operation processing is performed for setting a transmission control information group. In this case, the destination ID information is set as the vehicle communication terminal ID which has been obtained in step S5. The maximum transmission power information value is set as “99 dBm”. As described above, this information constitutes a command for halting further transmission of radio signals by a vehicle communication terminal 2 which is specified by the destination ID information. The time stamp information is then set, and the distribution source ID is set as the roadside apparatus ID of the local roadside base station 1. The distribution path information is set as “0”.

In step S7, the operation management apparatus 18 determines the road-to-vehicle service information that is to be transmitted together with the transmission control information group. In step S8, processing is performed for transmitting the transmission control information group and road-to-vehicle service information by the radio transmit/receive circuit 13. The operation sequence is then ended.

Specifically, in the transmission processing of step S8, the road-to-vehicle service information which has been obtained by the operation management apparatus 18 and the newly generated transmission control information group (generated in step S4 or step S6) are transferred by the operation management apparatus 18 to the control section 16 via the operation management I/F 12 to the transmission information processing circuit 15, to be transmitted by the radio transmit/receive circuit 13.

FIG. 6 is a flow diagram of a special operation sequence executed by a roadside base station 1 when it is required that all vehicles in the service area of the roadside base station 1 are to be inhibited from radio transmissions. To achieve this, the roadside base station 1 transmits a specific transmission control information group which functions as an “all-vehicle transmission halt command”. With this embodiment, such a transmission control information group is issued by a roadside base station 1 in response to a command transmitted from the management center to the operation management apparatus 18.

Firstly (step S21) when the roadside base station 1 receives a radio signal from a vehicle communication terminal 2 which conveys vehicle running condition information, step S22 is then executed. In step S22, the information concerning vehicle running conditions (obtained from the received radio signal through demodulation and decoding by the received information processing circuit 14) is transferred via the operation management I/F 12 to the operation management apparatus 18.

Next in step S23, processing is performed for generating a transmission control information group by the transmission control designation information generating section 19 and transferring this to the roadside communication terminal 11. This transmission control information group has the destination ID set as “99999999”, indicating that it is directed to all of the vehicle communication terminals 2 within the service area of the local roadside base station 1. The maximum transmission power information is set as “99 dBm”, indicating that each vehicle communication terminal 2 which is specified as a destination is to (temporarily) halt transmissions of radio signals. The time stamp information is set as the current time point, and the distribution source ID is set as the roadside apparatus ID of the local roadside base station 1.

Next in step S24, road-to-vehicle service information is obtained by the operation management apparatus 18, then (step S25) transmission processing is performed. In this transmission processing, the (most recent) road-to-vehicle service information obtained by the operation management apparatus 18 and the newly generated transmission control information group are transferred via the operation management I/F 12 to the control section 16, and supplied by the control section 16 to the transmission information processing circuit 15, to be transmitted by the radio transmit/receive circuit 13.

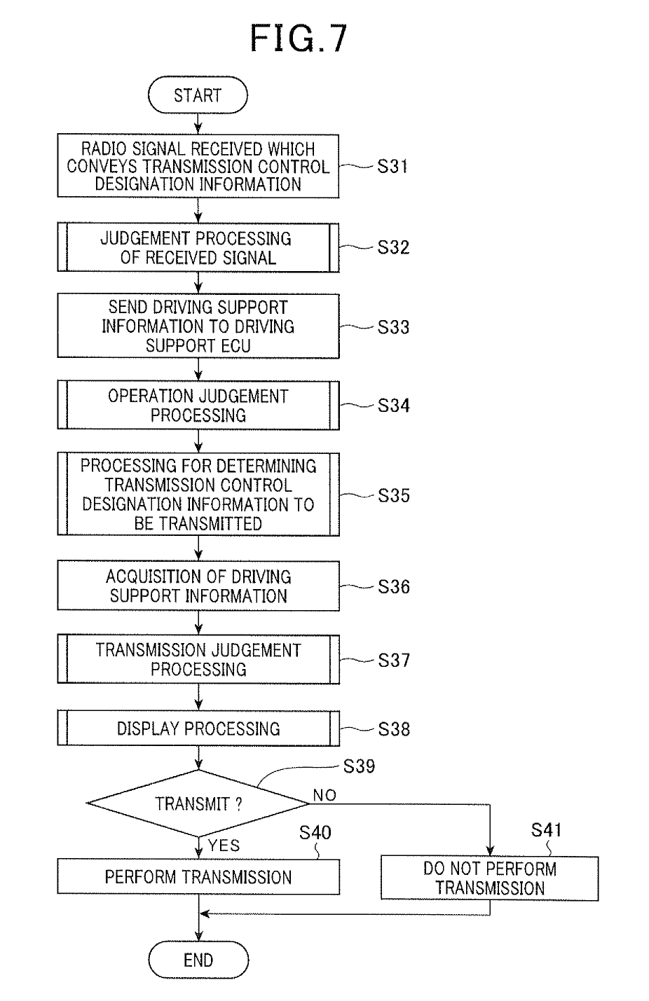

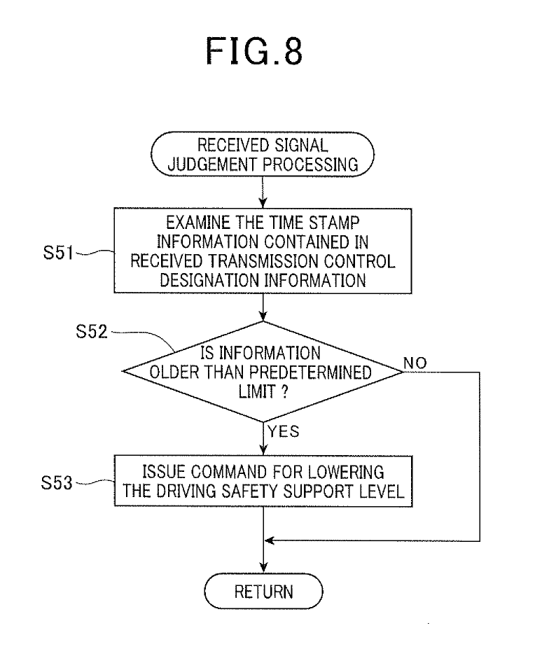

FIG. 7 is a flow diagram of an operation sequence performed by a vehicle communication terminal 2. The sequence is executed (after operating power has been applied to the vehicle communication terminal 2) each time a radio signal conveying a transmission control information group is received. Firstly (step S31) when a radio signal is received, the received information processing circuit 23 performs demodulation and decoding of the signal and supplies the results to the control section 27. If these results are found to constitute a transmission control information group, step S32 is then executed, in which judgement processing is performed. The general features of this judgement processing will be described referring to the flow diagram of FIG. 8.

Firstly (step S51) the time stamp information contained in the received transmission control information group is acquired and examined by the control section 27, to determine whether the time difference between the current time point and the time point expressed by the time stamp information exceeds a predetermined extent. Specifically, in step S51 the control section 27 acquires the current time point as measured by the timing circuit 25, and compares that with the time point expressed by the time stamp information. Next in step S52, a decision is made as to whether the time stamp information is older than the predetermined extent, and if so (YES decision), step S53 is executed. If the time stamp information is not judged to be older than the predetermined extent (NO decision), step S33 of FIG. 7 is then executed. The maximum age of the time stamp information can be predetermined for example as several weeks or months.

In step S33 the control section 27 sends a command via the vehicle LAN I/F 21 to the driving support ECU 32 designating a lowering of the driving safety support level, and this lowering is then executed by the driving support ECU 32. As described above, there are four successively increasing levels of driving safety support, i.e., (1) providing information to the driver, (2) generating precautionary messages, (3) generating warning signals, and (4) intervention (taking control of braking, etc., of the vehicle). With this embodiment, execution of a command for lowering the driving safety support level has the effect of lowering the driving safety support by one level.

For example when a vehicle communication terminal 2 receives a transmission control information group from the vehicle communication terminal 2 of another vehicle and it is judged that this transmission control information group is outdated, then this may be due to defective operation of the vehicle communication terminal 2 of the other vehicle. Hence, the contents of the received transmission control information group may be unreliable. In that case, with this embodiment, the driving safety support control is set at a level which is lower (by one level) than it would normally be set. This serves to lessen any adverse effects of errors in received information.

Returning to FIG. 7, in step S33 the control section 27 sends driving support information to the driving support ECU 32 (via the vehicle LAN I/F 21). This consists of information concerning running conditions of other vehicles and road-to-vehicle service information, which has been received together with the transmission control information group. The driving support ECU 32 executes driving safety support based on this information.

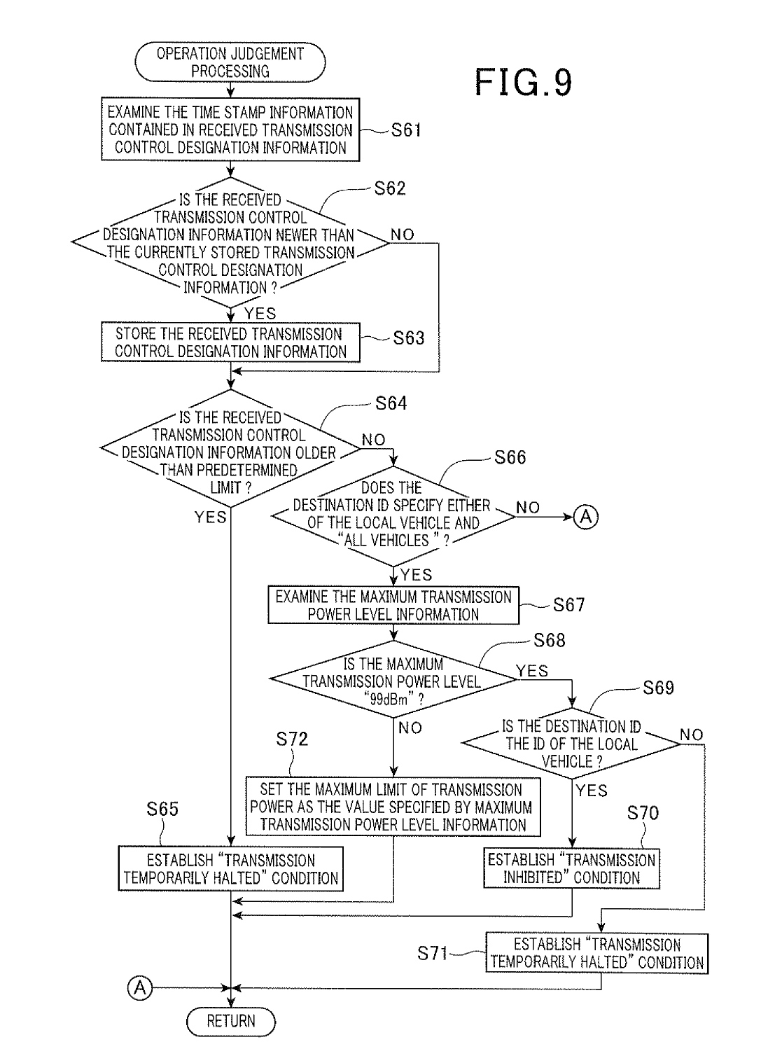

Next, operating judgement processing is executed in step S34, and step S35 is then executed. The contents of the operating judgement processing are shown in the flow diagram of FIG. 9. Firstly (step S61) the time stamp information contained in the currently received transmission control information group is acquired (from the received information processing circuit 23) by the control section 27, and is checked. Specifically, the time point expressed by the currently received time stamp information is compared with the time point expressed by the time stamp information in the transmission control information group which is currently held stored in the transmission control designation information storage section 28.

Next in step S62 a decision is made, based on the time stamp information, as to whether the currently received transmission control information group is newer than the transmission control information group which is currently held stored in the transmission control designation information storage section 28. If the currently received transmission control information group is judged to be newer (YES decision), step S63 is then executed, while otherwise (NO decision), step S64 is then executed.

In step S63, the currently received transmission control information group is stored in the transmission control designation information storage section 28 by the control section 27, replacing the previously stored transmission control information group.

Next in step S64, based on the time stamp information contained in the currently received transmission control information group and the current time point as measured by the timing circuit 25, a decision is made as to whether the currently received transmission control information group is outdated (i.e., is older than a predetermined limit of several weeks or several months). If this transmission control information group is judged to be outdated (YES decision), step S65 is then executed while otherwise (NO decision), step S66 is then executed.

As described above, the predetermined extent can be for example several weeks or several months.

In step S65, the control section 27 performs temporary transmission halt setting, whereby radio signal transmission by the radio transmit/receive circuit 22 is temporarily halted. The condition of halted transmission is continued until a normal-operation transmission control information group is subsequently received, i.e., a transmission control information group in which the maximum transmission power information is other than “99 dBm” or “00 dBm”.

In step S66, the control section 27 reads out the transmission control information group that is currently held in the transmission control designation information storage section 28, and examines the destination ID therein. If the destination ID is found to be the vehicle communication terminal ID of the local vehicle or specifies all of the vehicles (i.e., is “99999999”), step S67 is then executed (YES decision). Otherwise (NO decision), step S35 of FIG. 7 is then executed.

In step S67, the control section 27 examines the maximum transmission power information contained in the currently held transmission control information group (i.e., which was read out from the transmission control designation information storage section 28 in step S66). Next in step S68, the control section 27 judges whether the maximum transmission power information is “99 dBm”. If the maximum transmission power information is “99 dBm” (YES decision), step S69 is then executed, while otherwise (NO decision) step S72 is then executed.

In step S69 the destination ID contained in the currently held transmission control information group is examined. If the destination ID is found to be the vehicle communication terminal ID of the local vehicle (YES decision), step S70 is then executed, while otherwise (NO decision) step S71 is then executed.

In step S70 the control section 27 performs transmission inhibition setting, for halting transmitting of radio signals by the radio transmit/receive circuit 22, and step S35 is then executed. When this transmission inhibition setting of step S70 has been performed, the radio transmit/receive circuit 22 is thereafter prevented from transmitting radio signals even if a normal-operation transmission control information group (i.e., in which the maximum transmission power information is other than “99 dBm” or “00 dBm”) is subsequently received.

In step S71 the control section 27 sets the temporary transmission halted condition, as described above concerning step S65.

In step S72, the control section 27 performs maximum transmission power setting, for determining the maximum power level at which radio signals are transmitted by the radio transmit/receive circuit 22, and step S35 is then executed. Specifically, the value specified by the maximum transmission power information contained in the transmission control information group which has been read out from the transmission control designation information storage section 28 is set as the upper limit of power at which radio signals are to be transmitted by the radio transmit/receive circuit 22. If the maximum transmission power information contained in that transmission control information group is “00 dBm”, then a predetermined default value is set as the upper limit of transmission power.

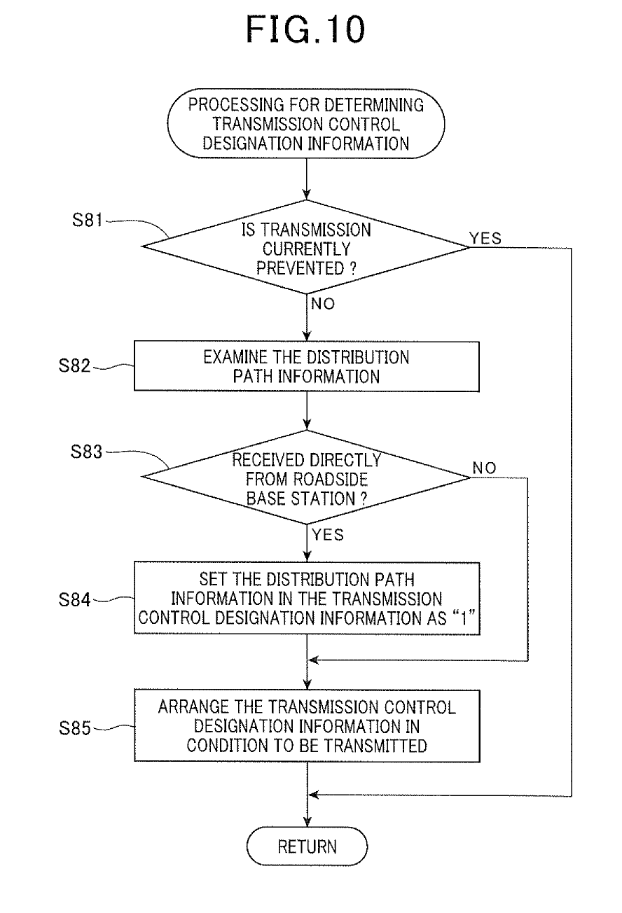

Returning to FIG. 7, transmission control information setting processing (i.e., setting of the contents of a transmission control information group that is to be transmitted by this vehicle communication terminal 2) is performed in step S35, then step S36 is executed in which driving safety support information is acquired. The contents of step S35 will be described referring to the flow diagram of FIG. 10.

Firstly (step S81) the control section 27 reads out the transmission control information group that is held in the transmission control designation information storage section 28, and judges whether transmission of radio signals is currently prevented. If it is judged that transmission is prevented (YES decision) then step S36 is executed, while if transmission is currently enabled,(NO decision) step S82 is then executed.

In step S82 the control section 27 examines the distribution path information contained in the currently held transmission control information group, then step S83 is executed. Specifically in step S83, the control section 27 judges whether the distribution path information has the value “0” or “1”. If the value is “0”, indicating that the transmission control information group has been received directly from a roadside base station 1, a YES decision is made in step S83, and step S84 is then executed. However if the distribution path information has the value “1”, indicating that the transmission control information group has been received indirectly from a roadside base station 1 (i.e., has been received via the vehicle communication terminal 2 of another vehicle) (NO decision in step S83), the distribution path information is left unchanged as “1”, and step S85 is then executed.

In step S84, the distribution path information of this transmission control information group is set as “1”, and step S85 is then executed in which the control section 27 arranges the contents of the transmission control information group in condition for being transmitted (e.g., in the format shown in FIG. 4), and step S36 is then executed. With this embodiment, other than for the distribution path information, the contents of a modified transmission control information group that is transmitted by a vehicle communication terminal 2 are left identical to those of the transmission control information group that is currently held in the storage section 28.

Returning to FIG. 7, driving support information is received by the control section 27 from the sensors 31 and the driving support ECU 32 via the vehicle LAN I/F 21 in step S36, and step S37 is then executed. The driving support information consists of information on the running conditions of the local vehicle (detected by the sensors 31), and information concerning the running conditions of other vehicles and road-to-vehicle service information (sent to the driving support ECU 32 in step S33).

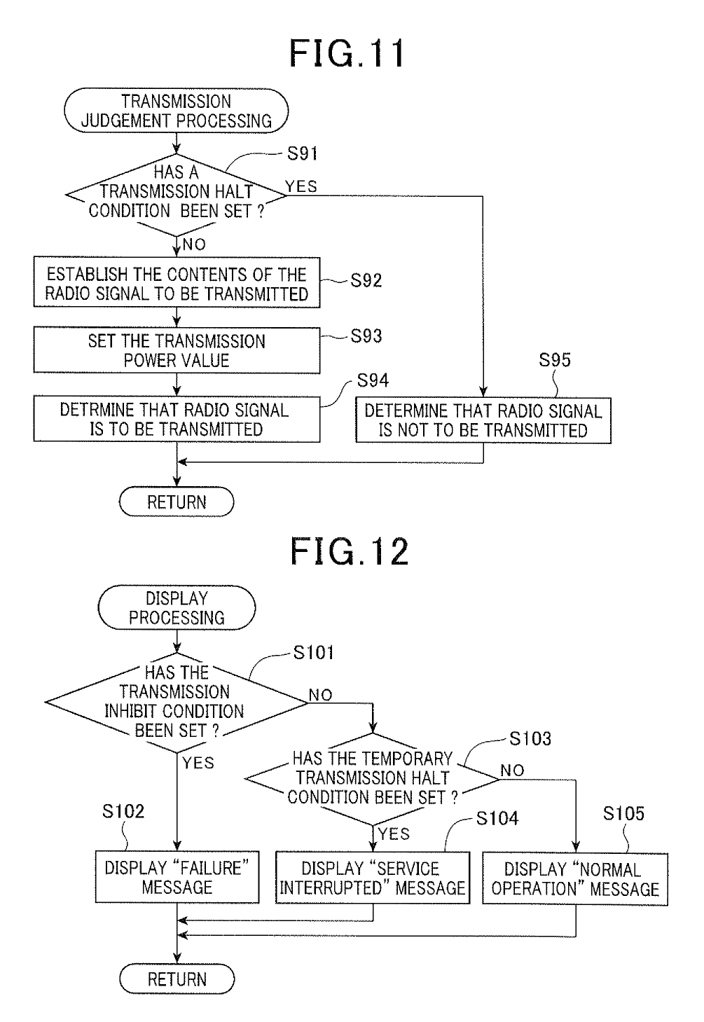

Transmission judgement processing is performed in step S37, and step S38 is then executed. The transmission judgement processing will be described referring to the flow diagram of FIG. 11.

Firstly (step S91) the control section 27 judges whether transmission is currently prevented (as a result of the operation judgement processing of step S34). If transmission is currently prevented (YES decision), step S95 is then executed, while otherwise, (NO decision), step S92 is then executed.

In step S92 the transmission information processing circuit 24 generates the contents of a radio signal to be transmitted by the radio transmit/receive circuit 22, conveying the transmission control information group that has been established in step S85 and the information that has been received by the control section 27 in step S36, and step S93 is then executed. In step S93 the transmission power level of the radio transmit/receive circuit 22 is set, then step S94 is executed. If a maximum limit value of radio signal transmission power has been determined, the transmission power level is set as a value which does not exceed that maximum limit. If a maximum limit value has not been set, a default value of transmission power is set.

In step S94, the control section 27 determines that the radio signal is to be transmitted by the radio transmit/receive circuit 22, at the power level that has been set. Step S38 is then executed.

However if the control section 27 determines that the radio signal is not to be transmitted (step S95), step S38 is then executed directly.

Returning to FIG. 7, display processing is performed in step S38, and step S39 is then executed. The contents of the display processing are shown in the flow diagram of FIG. 12. Firstly (step S101), the control section 27 judges whether or not transmission inhibition (i.e., non-temporary halting of transmission) has been set by step S70 of the operation judgement processing of FIG. 9 above. If this transmission inhibition condition has been set (YES decision), step S102 is then executed, while if it has not been set (NO decision), step S103 is then executed. In step S102, the control section 27 sends a command to the display control section 26 for generating a display indication such as “equipment failure” to indicate that there is a failure condition, and step S39 is then executed.

In step S103, the control section 27 judges whether or not a temporary transmission halt has been set (by step S71 of the operation judgement processing of FIG. 9 above). If a temporary transmission halt has been set (YES decision), step S104 is then executed, while if it has not been set, step S105 is executed. In step S104 the control section 27 sends a command to the display control section 26 for generating a display indication by the display unit 33 that inter-vehicle communication service by the host vehicle is temporarily halted, e.g., by displaying a message such as “service interrupted”. Step S39 is then executed.

In step S105, the control section 27 sends a command to the display control section 26 for generating a display indication by the display unit 33 that communication operation is normal, e.g., by displaying a message such as “normal service”. Step S39 is then executed.

In the flow diagram of FIG. 7, it is assumed that the display processing (step S8) is performed following transmission judgement processing (step S37). However this is not essential, and it would be equally possible to perform the display processing prior to the transmission judgement processing.

Returning to FIG. 7, a YES decision is made in step S39 if the control section 27 has determined (by step S94 of the transmission judgement processing of FIG. 11) that a radio signal is to be transmitted. In that case, step S40 is executed in which a radio signal conveying the contents which have been set (in step S92 of the transmission judgement processing) is transmitted by the radio transmit/receive circuit 22 from the antenna 22a, at the transmission power level which has been determined in step S93 of the transmission judgement processing. The operation sequence of FIG. 7 is then ended.

A NO decision is made in step S39 if the control section 27 has determined (step S95 of the transmission judgement processing of FIG. 11) that radio signal transmission is to be prevented. In that case (step S41) control is performed to prevent a radio signal from being transmitted by the radio transmit/receive circuit 22. The operation sequence of FIG. 7 is then ended.

With the above embodiment, transmission control of the radio transmit/receive circuit 22 can be performed in accordance with transmission control information which is received as a radio signal directly from a roadside base station 1 or indirectly from a roadside base station via a vehicle communication terminal of another vehicle. Hence it is unnecessary for a vehicle driver to manually control radio signal transmissions by a vehicle communication terminal installed in the vehicle. This is highly advantageous, since such manual control would be difficult for a driver to perform.

With a vehicle communication system, the service area of each roadside base station is of very limited size. It has thus not been possible to achieve transmission control of vehicle communication terminals over a large service area, as is possible for a cell phone system.

However with the embodiment described above, the vehicle communication terminal of a vehicle can receive transmission enable/halt command information and transmission power command information conveyed by radio signals which may be received via (i.e., relayed via) vehicle communication terminals of other vehicles, with the transmission enable/halt command information and transmission power command information having been originally transmitted from a roadside base station. Hence, the vehicle communication terminal of a local vehicle can perform transmission control (i.e., without manual intervention by the vehicle driver) of the radio transmit/receive circuit of that vehicle communication terminal even when the local vehicle is located in an area where direct communication with a roadside base station is impossible.

The effective area of communication control can thereby be made substantially larger than the communication area of a single roadside base station of the system.

Furthermore with the above embodiment, a degree of transmission control of the radio transmit/receive circuit of a vehicle communication terminal, in accordance with a received transmission control information group (i.e., which had been originally generated by a roadside base station 1), can be altered in accordance with the length of time that has elapsed since the transmission control information group was generated. Specifically, the received transmission control information group may be judged to be excessively old (based on the time stamp information), so that the contents of the transmission control information group may not be valid. In that case, with the above embodiment, transmission of radio signals by the radio transmit/receive circuit 22 of the vehicle communication terminal 2 is temporarily halted. This halted condition is continued until a valid transmission control information group is newly received (i.e., in which the time stamp information is not found to be outdated). In that way, transmission control based upon outdated (and therefore possibly unreliable) received information can be avoided.

In the above description relating to FIG. 5, it is assumed that the transmission processing step S8 is performed only when a radio signal is newly received from a vehicle communication terminal. However it will be understood that the apparatus may be configured such that this step is also periodically executed (using the most recently generated transmission control designation information and road-to-vehicle service information) at other times. Similarly, each vehicle communication terminal may be configured to also execute the transmission step S40 of FIG. 7 periodically (using the most recently acquired transmission control designation information and road-to-vehicle service information), e.g., each time that the vehicle communication terminal transmits information concerning the running conditions of the corresponding vehicle.

Furthermore with the above embodiment, a transmission control information group contains time stamp information, maximum transmission power information, transmission enable/halt information (in this case, combined with the maximum transmission power information), destination ID, distribution source ID, and distribution path information. However the invention is not limited to such contents. For example, it may be possible to omit the time stamp information, the distribution source ID, or the distribution path information. Similarly, it may be possible to omit the destination ID, in which case the destination of each transmission control information group would be all of the vehicle communication terminals of the vehicles within the service area of a roadside base station.

Alternatively, the maximum transmission power information or the transmission enable/halt information (or both of these) could be omitted.

Furthermore, it would be possible for each transmission control information group to contain information or commands other than those of the above embodiment. For example, each transmission control information group can include a command for changing the frequency band used by the radio transmit/receive circuit of a vehicle communication terminal for communication, e.g., by changing the resonance frequency of the antenna 22a.

Moreover, control-time information can be transmitted by a base station together with a transmission control information group. The control-time information specifies a time point at which a vehicle communication terminal (which receives this transmission control information group) is to begin applying transmission control in accordance with the transmission control information group. Such control-time information may designate a delay interval after which the transmission control is to be executed. Specifically, the control section would acquire current time information, and detect the time that elapses following the point at which the transmission control information group is received. When the elapsed time becomes equal to the delay interval specified by the control-time information, transmission control is applied in accordance with the received transmission control information group.

Alternatively, such time point information may directly specify a time point at which the transmission control is to begin to be applied. In that case the control section of a vehicle communication terminal would be configured to acquire current time information, compare the current time point with the specified time point, and initiate transmission control in accordance with the contents of the transmission control information group when the specified time point is reached.

It will be understood that it may not be necessary for the control section 27 itself to perform a timing (current time measurement) function, since in general it will be possible to acquire current time information from other equipment of a host vehicle, such as a vehicle navigation apparatus, etc.

Furthermore with the above embodiment, a roadside base station can transmit transmission control designation information to a specific vehicle communication terminal (by executing step S6 of FIG. 5, in which the ID of that vehicle communication terminal is specified as a destination) only when the vehicle communication terminal is judged to be functioning abnormally. However the essential point is that ID information of a destination vehicle communication terminal can be specified in a transmission control information group. Hence, respectively separate transmission control designation information can be directed to various vehicle communication terminals.

Thus although the present invention has been described above referring to a specific embodiment, the scope of the invention as set out in the appended claims is not limited to the embodiment, and various modifications or alternative forms of the embodiment may be envisaged which fall within the scope claimed for the invention.

As can be understood from the description of the above embodiment, the present invention can provide a vehicle communication system having many of the advantages of a portable telephone system (e.g., cell phone system) with respect to transmission control of a mobile terminal, making it unnecessary for a user to perform manual control of transmissions by a vehicle-installed communication apparatus, and whereby the range within which transmission control commands (constituted by transmission control designation information) can be transmitted to vehicles of the system can be made substantially greater than the communication range of each roadside base station of the system. This is due to the fact that such commands and information can be successively relayed from a roadside base station via the vehicle communication terminals of respective vehicles. Integrated control of a vehicle communication system (by a management center which communicates with respective roadside base stations) within a wide area is thereby made possible.

In addition, the range within which commands and information can be transmitted to vehicles of the system can also be made substantially greater than the direct communication range of each roadside base station of the system, by including control-time information in a transmission control information group as described above. The received transmission control designation information is stored in memory by a vehicle communication terminal, to be read out when required. This enables a vehicle communication terminal to begin transmission control in accordance with that transmission control information group at a later time, i.e., at a time point determined by the control-time information. Thus this transmission control can be applied even when the vehicle communication terminal has moved outside the service area of the originating roadside base station.

In that way the effective service area of each roadside base station can be widened, since received transmission commands (transmission control designation information) are not required to be immediately applied at the time point of being received by a vehicle communication terminal.

What is claimed is:

1. A vehicle communication terminal conveyed by a motor vehicle, comprising a receiver circuit configured to receive externally transmitted radio signals and a transmitter circuit configured to transmit radio signals externally from said vehicle;
wherein said externally transmitted radio signals convey transmission control designation information relating to control of transmission operations of said transmitter circuit, and
said vehicle communication terminal comprises a transmission control circuit configured to be responsive to said transmission control designation information, when received by said receiver circuit, for controlling transmission operations of said transmitter circuit in accordance with said transmission control designation information.

2. A vehicle communication terminal as claimed in claim 1, wherein said transmission control designation information comprises transmission enable/halt information for selectively designating enabling and halting transmission of radio signals by said transmitter circuit, and wherein said transmission control circuit is configured to control said transmitter circuit to selectively enable and halt said transmission of radio signals by said transmitter circuit in accordance with said transmission enable/halt information.

3. A vehicle communication terminal as claimed in claim 1, wherein said transmission control designation information comprises transmission power-related information relating to a level of radio signal transmission power, and wherein said transmission control circuit is configured to control a level of transmission power of said transmitter circuit in accordance with said transmission power-related information.

4. A vehicle communication terminal as claimed in claim 3, wherein said transmission power-related information comprises maximum transmission power information specifying an upper limit level of power at which radio signals are to be transmitted by said transmitter circuit, and wherein said transmission control circuit is configured to control said transmitter circuit to limit a value of output power of said transmitter circuit in accordance with said upper limit specified by said maximum transmission power information.

5. A vehicle communication terminal as claimed in claim 1, wherein said transmission control designation information is transmitted together with control-time information expressing a time point for executing transmission control in accordance with said transmission control designation information by said transmission control circuit, and wherein said transmission control circuit is configured to initiate control of said transmitter circuit in accordance with said transmission control designation information at said time point expressed by said control-time information.

6. A vehicle communication terminal as claimed in claim 5, wherein
said control-time information specifies a time duration which is to elapse before said transmission control is to be initiated by said transmission control circuit,
said receiver circuit is configured to measure a time interval that has elapsed since a time point of receiving said transmission control designation information, and
said transmission control circuit is configured to commence execution of said transmission control in accordance with said transmission control designation information when said elapsed time interval coincides with said time duration specified by said control-time information.

7. A vehicle communication terminal as claimed in claim 5, comprising a current time measurement circuit for measuring a current time point, and wherein
said control-time information specifies a time point at which said transmission control is to be initiated by said transmission control circuit, and
said transmission control circuit is configured to commence execution of said transmission control in accordance with said transmission control designation information when said current time point coincides with said time point specified by control-time information.

8. A vehicle communication terminal as claimed in claim 1, wherein
said transmission control designation information comprises time stamp information expressing a time point at which said transmission control designation information was generated, and
said transmission control circuit is configured to utilize said time stamp information in performing transmission control of said transmitter circuit in accordance with said transmission control designation information.

9. A vehicle communication terminal as claimed in claim 8, comprising a current time measurement circuit for measuring a current time point, wherein said transmission control circuit is configured to modify utilization of currently received transmission control designation information when a difference between said time point expressed by said time stamp information of said currently received transmission control designation information and said current time point is judged to exceed a predetermined extent.

10. A vehicle communication system comprising
at least one vehicle communication terminal as claimed in claim 1, conveyed by a vehicle, and
at least one base station apparatus configured to transmit radio signals conveying said transmission control designation information;
wherein said receiver circuit of said vehicle communication terminal is configured to receive said radio signals transmitted by said base station apparatus, and wherein said transmission control circuit of said vehicle communication terminal is configured to perform transmission control of said transmitter circuit in accordance with said transmission control designation information conveyed by said radio signal from said base station apparatus.

11. A vehicle communication system as claimed in claim 10, wherein said base station apparatus comprises a roadside communication apparatus located adjacent to a road.

12. A vehicle communication system as claimed in claim 10, comprising a plurality of said vehicle communication terminals, conveyed by respective vehicles.

13. A vehicle communication system as claimed in claim 12, wherein each of said vehicle communication terminals conveyed by a vehicle
comprises an inter-vehicle communication circuit configured for effecting inter-vehicle communication to exchange information with a vehicle communication terminal conveyed by another one of said plurality of vehicles, and
receives, through said inter-vehicle communication, a radio signal transmitted from another one of said vehicle communication terminals conveying information previously received by said another vehicle communication terminal from a base station apparatus as a radio signal;
and wherein said received information comprises at least one of said transmission enable/halt information and said maximum transmission power information.

14. A vehicle communication system as claimed in claim 12, wherein
said transmission control designation information includes destination information, identifying at least one of said plurality of vehicle communication terminals as a vehicle communication terminal which is required to perform transmission control of said transmitter circuit thereof in accordance with said transmission control designation information, and
said transmission control circuit is configured for performing transmission control of said transmitter circuit in accordance with said transmission control designation information only when the vehicle communication terminal corresponding to said transmission control circuit is identified by said destination information contained in said transmission control designation information.
